(19) United States
(12) Patent Application Publication
(10) Pub. No.: US 2005/0248268 A1
(43) Pub. Date: Nov. 10, 2005

(54) Cloth textured EL lamp

(75) Inventors: David A. Hardinger, Apache Junction, AZ (US); David G. Pires, Phoenix, AZ (US)

Correspondence Address: Paul F. Wille;Durel Division Rogers Corporation, 2225 W. Chandler Boulevard, Chandler, AZ, 85224, US

(73) Assignee: World Properties, Inc., Lincolnwood, IL (US)

(21) Appl. No.: 10/839,461

(22) Filed: May 5, 2004

(51) Int. Cl. H05B 33/00

(52) U.S. Cl. 313/509

(57) ABSTRACT

A textured EL panel includes a translucent sheet having a first major surface and a second major surface, with flock disposed on the first major surface and EL lamp materials disposed on the second major surface. The EL lamp materials include a front electrode, a phosphor layer, a dielectric layer, and a rear electrode. The lamp materials can be screen printed or laminated on the second major surface and the panel can be molded into a three dimensional object.

### BACKGROUND OF THE INVENTION

This invention relates to a thick film, inorganic, electroluminescent (EL) lamp and, in particular, to such an EL lamp having a cloth-like texture.

As used herein, and as understood by those of skill in the art, “thick-film” refers to one type of EL lamp and “thin-film” refers to another type of EL lamp. The terms only broadly relate to thickness and actually identify distinct disciplines. In general, thin film EL lamps are made by vacuum deposition of the various layers, usually on a glass substrate or on a preceding layer. Thick-film EL lamps are generally made by depositing layers of inks on a substrate, e.g. by roll coating, spraying, or various printing techniques. The techniques for depositing ink are not exclusive, although the several lamp layers are typically deposited in the same manner, e.g. by screen printing. A thin, thick-film EL lamp is not a contradiction in terms and such a lamp is considerably thicker than a thin film EL lamp.

In the context of a thick film EL lamp, and as understood by those of skill in the art, “inorganic” refers to a crystalline, luminescent material, phosphor, that does not contain silicon or gallium as the host crystal. (A crystal may be doped accidentally, with impurities, or deliberately. “Host” refers to the crystal itself, not a dopant.) The term “inorganic” does not relate to the other materials from which an EL lamp is made. Thick film EL phosphor particles are typically zinc sulfide-based materials containing small amounts of other materials as color centers, as activators, or to modify defects in the crystal lattice to modify properties of the phosphor as desired.

As used herein, an EL “panel” is a single sheet including one or more luminous areas, wherein each luminous area is an EL “lamp.” An EL lamp is essentially a capacitor having a dielectric layer between two conductive electrodes, at least one of which is transparent. The dielectric layer can include a phosphor powder or there can be a separate layer of phosphor powder adjacent the dielectric layer. The phosphor powder radiates light in the presence of a strong electric field, using relatively little current.

A modern (post-1990) EL lamp typically includes transparent substrate of polyester or polycarbonate material having a thickness of about 7.0 mils (0.178 mm.). A transparent, front electrode of indium tin oxide or indium oxide is vacuum deposited onto the substrate to a thickness of 1000A° or so. A phosphor layer is screen printed over the front electrode and a dielectric layer is screen printed over phosphor layer. A rear electrode is screen printed over the dielectric layer. It is also known in the art to deposit the layers by roll coating.

The inks used for screen printing include a binder, a solvent, and a filler, wherein the filler determines the nature of the ink. As long known in the art, having the solvent and binder for each layer be chemically the same or chemically similar provides chemical compatibility and good adhesion between adjacent layers; e.g., see U.S. Pat. No. 4,816,717 (Harper et al.). It is known in the art to mold lamps into three dimensional shapes, e.g. as disclosed by U.S. Pat. No. 5,565,733 (Krafcik et al.) and its progeny.

EL lamps with textured surfaces have long been known in the art but only as appearance items, not as tactile objects. For example, U.S. Pat. No. 5,224,078 (Mallin) discloses a wrist watch having interchangeable face plates. U.S. Pat. No. 5,620,348 (Santana et al.) and U.S. Pat. No. 6,515,416 (Chico) discloses a surface treatment on a transparent layer to produce various visual effects. U.S. Pat. No. 5,964,514 (Carter et al.) discloses a textured surface on a gauge back lit by an EL lamp. The textured surface provides an anti-reflection function. While illustrated as coarsely textured, anti-reflection coatings generally have microscopic features rather than macroscopic features. Even so, none of the products known in the art appeals to the sense of touch.

EL lamps are primarily used commercially in a functional rather than decorative manner. There are patents disclosing EL lamps for accents on an automobile, shoe, backpack, and the like but commercial use is rare. Decorative uses for EL lamps would be substantially increased if the lamps appealed to two senses rather than one. Thus, there is a need in the art for a textured EL lamp that appeals to the sense of touch, in addition to the sense of sight.

It is known to transfer flock to a plastic substrate to produce a plushly textured surface; e.g., see U.S. Pat. No. 4,810,549 (Abrams et al.) and U.S. Pat. No. 5,047,103 (Abrams et al.). This technology permits varied, detailed, color designs to be produced in a strongly adherent, non-woven, cloth-like coating.

In view of the foregoing, it is therefore an object of the invention to provide an EL lamp that appeals to the senses of sight and touch.

Another object of the invention is to provide an EL lamp that has a cloth-like texture.

A further object of the invention is to provide an EL lamp having a textured surface that can be molded into a three dimensional shape.

### SUMMARY OF THE INVENTION

The foregoing objects are achieved in this invention in which a textured EL panel includes a translucent sheet having a first major surface and a second major surface, with flock disposed on the first major surface and EL lamp materials disposed on the second major surface. The EL lamp materials include a front electrode, a phosphor layer, a dielectric layer, and a rear electrode. The lamp materials can be screen printed or laminated on the second major surface and the panel can be molded into a three dimensional object.

### BRIEF DESCRIPTION OF THE DRAWINGS

A more complete understanding of the invention can be obtained by considering the following detailed description in conjunction with the accompanying drawings, in which:

FIG. 1 is a plan view of an EL lamp constructed in accordance with the invention;

FIG. 2 is a plan view of another EL lamp constructed in accordance with the invention;

FIG. 3 is a cross-section of an EL lamp constructed in accordance with a preferred embodiment of the invention; and

FIG. 4 is a three dimensional, molded article incorporating a textured lamp constructed in accordance with the invention.

### DETAILED DESCRIPTION OF THE INVENTION

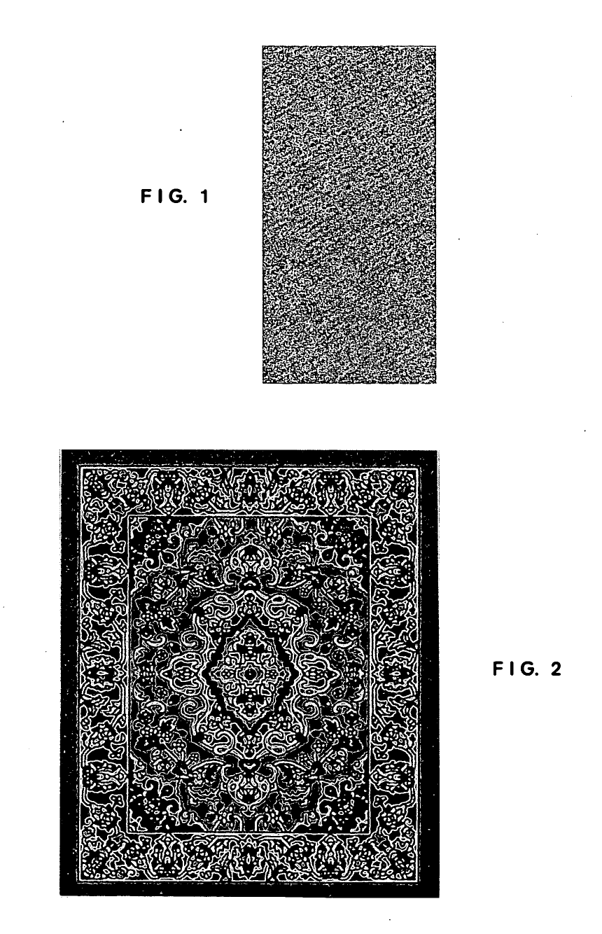

FIG. 1 is a plan view of an EL lamp having a textured surface in accordance with the invention. The surface has a fine, diagonal rib, reminiscent of indoor-outdoor carpeting or of the cloth upholstery in a car built in the 1940's. The ribbing, while slight, can be felt with the tip of a finger. Unlit, the lamp is gray in color. Any color can be used for lighting. This particular sample was bluish green when lit. The sample was made for proof of concept, not aesthetics. FIG. 1 and FIG. 2 were generated by scanning a sample on a flatbed scanner and restricting the colors to gray scale.

FIG. 2 illustrates the detail possible by using flock of several colors. The original is multi-colored. For example, the darkest areas are deep blue. The dark gray areas are magenta. The medium gray areas are deep yellow. The outer border is bluish gray and the light border is off white. The sample has a uniform texture and looks and feels like a miniature Persian rug.

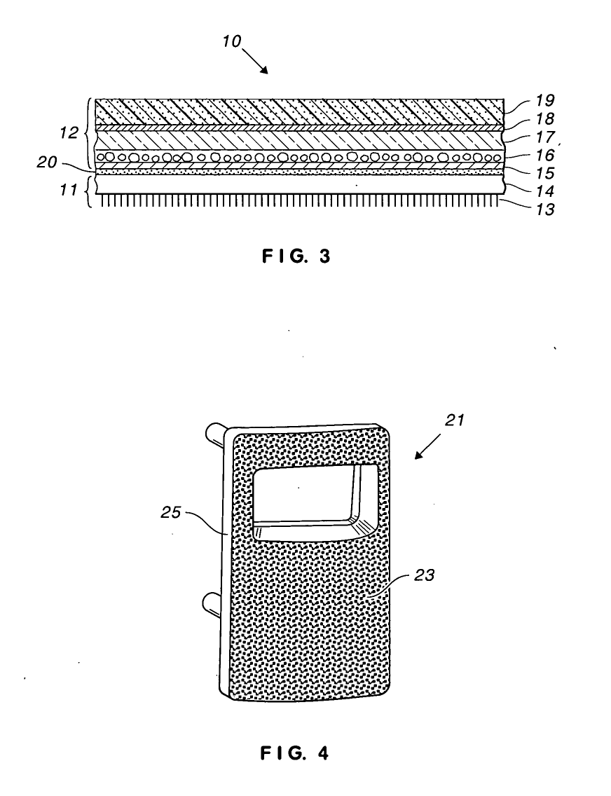

FIG. 3 is a cross-section of an EL lamp constructed in accordance with the invention. The various layers are not shown in proportion. The lamp includes textured substrate 11, which includes a translucent sheet of plastic such as polyester, polyurethane, or polycarbonate having opposed major surfaces. As oriented in FIG. 1, flock 13 is attached to the lower major surface of sheet 14. EL lamp materials 12 are applied to the upper major surface of the sheet 14, e.g. by screen printing. Most currently available lamp materials, whether solvent based or UV curable, are compatible with at least one of polycarbonate, polyester, or polyurethane.

Transparent front electrode 15 overlies sheet 14 and is a thin layer of conductive ink. Phosphor layer 16 overlies the front electrode and dielectric layer 17 overlies the phosphor layer. Layers 16 and 17 are combined in some applications. Overlying dielectric layer 17 is rear electrode 18. An optional backing layer 19 may also be provided, e.g. for sealing lamp 10. The flock can be patterned, i.e. not deposited over the entire surface of EL panel 10. Either electrode can be patterned to produce a desired effect with the design of flock that is deposited. EL panel 10 can include several lamps of different color by patterning the phosphor layer and by the use of suitable cascading layers, as known in the art. It is a distinct advantage of the invention that known processes and materials can be used to apply lamp materials 12 to the surface of substrate 11.

Layer 20 is an adhesion layer; that is, the layer represents either a surface treatment, such as wiping with adhesion promoter, or a layer that remains in the lamp, such as a resin layer to promote adhesion between substrate 11 and lamp materials 12. In one embodiment of the invention, layer 20 is a separate layer of resin having the approximately the same solvent and binder as the other layers in lamp materials 12.

Light from an EL lamp is generally Lambertian, i.e. brightness is a cosine function of the angle from normal. Light is emitted primarily through flock 13 from lamp 10 but, because of the flock, is non-Lambertian. The light is noticeably dimmer off-axis, with the attenuation dependent upon the length of the flock.

The flock has a second effect in that sound is muted slightly by the flock, again depending upon the length of the flock. The sound can come from the lamp itself or be incident upon the lamp.

FIG. 4 is a perspective view of a molded article incorporating a textured lamp constructed in accordance with the invention. Article 21, which could, for example, be a bezel for a gauge in an instrument panel, includes textured EL panel 23 molded into a three dimensional shape on the front surface of the article. Not all the textured surface need be luminous and, for example, the texture could be used to obscure a message visible when the EL panel is lit. The outer surface of the bezel includes an nontextured or differently textured rim to further enhance the appearance of the article. Thus, the texturing can be used for emphasis or de-emphasis of a feature. In this case, the front surface of the bezel would likely be textured to blend in with the rest of the instrument panel (not shown) or other area where a bezel is attached.

The invention thus provides an EL panel that appeals to the senses of sight and touch; in particular, an EL panel that has a cloth-like texture. Because the EL panel itself is made using known materials and techniques, a textured panel constructed in accordance with the invention can be molded into a three dimensional shape, also using known techniques.

Having thus described the invention, it will be apparent to those of skill in the art that various modifications can be made within the scope of the invention. For example, an EL panel can be constructed on a release paper and laminated to substrate 11. This technique is particularly useful for thin, highly flexible lamp materials, such as polyurethane. While referred to as having a “cloth” texture, the material is not usually pressed down, like felt. Rather the flock is generally oriented perpendicular to the plane of the lamp prior to molding, if any.

1. A textured EL panel comprising:
a translucent sheet having a first major surface and a second major surface;
flock disposed on said first major surface; and
EL lamp materials disposed on said second major surface.

2. The EL panel as set forth in claim 1 wherein said EL lamp materials include a front electrode, a phosphor layer, a dielectric layer, and a rear electrode.

3. The EL panel as set forth in claim 1 wherein said lamp materials are screen printed on said second major surface.

4. The EL panel as set forth in claim 1 wherein said lamp materials are laminated on said second major surface.

5. The EL panel as set forth in claim 1 wherein said panel is molded into a three dimensional object.
